(19) United States
(12) Patent Application Publication
(10) Pub. No.: US 2025/0324242 A1
(43) Pub. Date: Oct. 16, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Yuxin MAO, Beijing (CN)

(73) Assignee: Beijing Xiaomi Mobile Software Co., Ltd., Beijing (CN)

(21) Appl. No.: 18/881,762

(22) PCT Filed: Jul. 8, 2022
(86) PCT No.: PCT/CN2022/104742

§ 371 Date: Jan. 7, 2025

(51) Int. Cl. H04W 8/24; H04B 7/185; H04W 76/27

(52) U.S. Cl. CPC H04W 8/24; H04B 7/185; H04W 76/27

(57) ABSTRACT

Embodiments of the present invention provide an information processing method and apparatus, a communication device, and a storage medium. The information processing method performed by a first network device comprises: sending first information to a second network device and/or a user equipment (UE), wherein the first information is used for the second network device or the UE to determine an interrupt time period and/or a connection time period of a feeder link between the first network device and a ground station.

### CROSS-REFERENCE TO RELATED APPLICATION

The application is a U.S. National Stage of International Application No. PCT/CN2022/104742 filed on Jul. 8, 2022, the entire content of which is incorporated herein by reference.

### TECHNICAL FIELD

The present disclosure relates to the technical field of wireless communication but is not limited to the technical field of wireless communication, and in particular, to a method and apparatus, a communication device and a storage medium.

### BACKGROUND

Satellite access network may not be able to provide continuous coverage services due to issues such as insufficient satellite deployment or limited coverage. There is a situation in which no satellite signal coverage exists in a specified area within a certain period of time, which is a kind of discontinuous coverage of satellite signals.

This discontinuous coverage includes: the situation of the discontinuous connection of the service link between the satellite and the UE or the situation of the discontinuous connection of the feeder link between the satellite and the ground receiving station.

The service link can also be called a service connection; and the feeder link can also be called a feeder connection.

### SUMMARY

Embodiments of the present disclosure provide an information processing method and apparatus, a communication device, and a storage medium.

A first aspect of the embodiments of the present disclosure provides an information processing method, which is executed by a first network device. The method includes:
sending first information to a second network device and/or a User Equipment (UE), where the first information is used for the second network device or the UE to determine an interruption period and/or a connection period of a feeder link between the first network device and a ground station.

A second aspect of the embodiments of the present disclosure provides an information processing method, which is executed by a second network device. The method includes:
receiving first information sent by a first network device, where the first information is used for the second network device to determine an interruption period and/or a connection period of a feeder link between the first network device and a ground station.

A third aspect of the embodiments of the present disclosure provides an information processing method, which is executed by a third network device. The method includes:
receiving a buffer instruction sent by a second network device; where the buffer instruction is determined according to first information between a first network device corresponding to a user equipment (UE) and a ground station; the first information is used to determine an interruption period and/or a connection period of a feeder link between the first network device and the ground station; and
buffering downlink data according to the buffer instruction, or notifying a fourth network device to buffer the downlink data.

A fourth aspect of the embodiments of the present disclosure provides an information processing method, which is executed by user equipment (UE). The method includes:
receiving first information sent by a first network device, where the first information is used for the UE to determine an interruption period and/or a connection period of a feeder link between the first network device and a ground station.

A fifth aspect of the embodiments of the present disclosure provides an information processing apparatus. The apparatus includes:
a first sending module, configured to send first information to a second network device and/or a user equipment (UE), where the first information is used for the second network device or the UE to determine an interruption period and/or a connection period of a feeder link between a first network device and a ground station.

A sixth aspect of the embodiments of the present disclosure provides an information processing apparatus. The apparatus includes:
a first receiving module, configured to receive first information sent by a first network device, where the first information is used for a second network device to determine an interruption period and/or a connection period of a feeder between the first network device and a ground station.

A seventh aspect of the embodiments of the present disclosure provides an information processing apparatus. The apparatus includes:
a second receiving module, configured to receive a buffer instruction sent by a second network device; where the buffer instruction is determined according to first information between a first network device corresponding to a user equipment (UE) and a ground station; the first information is used to determine an interruption period and/or a connection period of a feeder link between the first network device and the ground station; and
an execution module, configured to buffer downlink data according to the buffer instruction, or to notify a fourth network device to buffer the downlink data.

An eighth aspect of the embodiments of the present disclosure provides an information processing apparatus. The apparatus includes:
a third receiving module, configured to receive first information sent by a first network device, where the first information is used for a UE to determine an interruption period and/or a connection period of a feeder link between the first network device and a ground station.

A ninth aspect of the embodiments of the present disclosure provides a communication device, including a processor, a transceiver, a memory, and an executable program stored in the memory and capable of being run by the processor, where when the processor runs the executable program, the information processing method provided in any one of the foregoing first to fourth aspects is executed.

A tenth aspect of the embodiments of the present disclosure provides a computer storage medium storing an executable program; after the executable program is executed by a processor, the information processing method provided any one of the foregoing first to fourth aspects can be implemented.

According to the technical solutions provided by the embodiments of the present disclosure, the first network device can send the first information to the second network device or UE, and then the second network device and/or UE can know the connection period and/or interruption period of the feeder link, and sends or buffers data accordingly, which facilitates the development of some services that tolerate long delays in the condition of discontinuous feeder connection.

It should be understood that the above general description and the following detailed description are only exemplary and explanatory, and do not limit the embodiments of the present disclosure.

### BRIEF DESCRIPTION OF THE DRAWINGS

The accompanying drawings, which are incorporated in and constitute a part of this specification, illustrate the embodiments consistent with the present disclosure, and together with the specification, serve to explain the principles of the embodiments of the present disclosure.

FIG. 1 is a schematic structural diagram of a wireless communication system according to an exemplary embodiment.

FIG. 2 is a schematic flowchart of an information processing method according to an exemplary embodiment.

FIG. 3 is a schematic diagram of a network connection according to an exemplary embodiment.

FIG. 4A is a schematic flowchart of an information processing method according to an exemplary embodiment.

FIG. 4B is a schematic flowchart of an information processing method according to an exemplary embodiment.

FIG. 5 is a schematic flowchart of an information processing method according to an exemplary embodiment.

FIG. 6 is a schematic flowchart of an information processing method according to an exemplary embodiment.

FIG. 7 is a schematic flowchart of an information processing method according to an exemplary embodiment.

FIG. 8 is a schematic flowchart of an information processing method according to an exemplary embodiment.

FIG. 9 is a schematic flowchart of an information processing method according to an exemplary embodiment.

FIG. 10 is a schematic structural diagram of an information processing apparatus according to an exemplary embodiment.

FIG. 11 is a schematic structural diagram of an information processing apparatus according to an exemplary embodiment.

FIG. 12 is a schematic structural diagram of an information processing apparatus according to an exemplary embodiment.

FIG. 13 is a schematic structural diagram of an information processing apparatus according to an exemplary embodiment.

FIG. 14 is a schematic structural diagram of a UE according to an exemplary embodiment.

FIG. 15 is a schematic structural diagram of a network device according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with the embodiments of the present disclosure. Rather, they are merely examples of apparatus and methods consistent with some aspects of the embodiments of the present disclosure.

The terms used in the embodiments of the present disclosure are for the purpose of describing specific embodiments only and are not intended to limit the embodiments of the present disclosure. As used in the present disclosure, the singular forms “a/an,” “said” and “the” are intended to include the plural forms as well, unless the context clearly dictates otherwise. It should also be understood that the term “and/or” as used herein refers to and includes any or all possible combinations of one or more of the associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, the first information may also be called second information, and similarly, the second information may also be called first information. Depending on the context, the word “if” as used herein may be interpreted as “when” or “upon” or “in response to determination.”

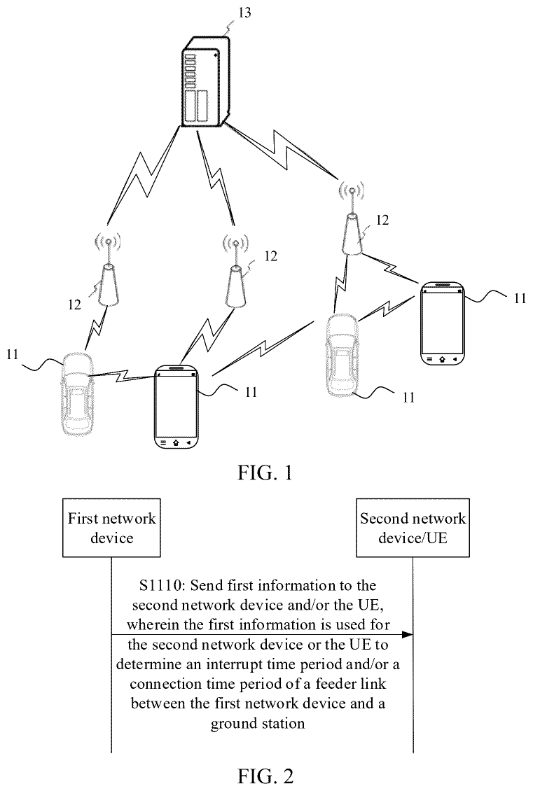

Referring to FIG. 1, a schematic structural diagram of a wireless communication system provided by an embodiment of the present disclosure is shown. As shown in FIG. 1, the wireless communication system is a communication system based on cellular mobile communication technology. The wireless communication system may include: several UEs 11, several access devices 12 and a core network. Generally, the UEs 11 communicate with the core network 11 through the access devices 12.

The UE 11 may refer to a device that provides voice and/or data connectivity to the user. The UE 11 may communicate with one or more core networks via a Radio Access Network (RAN). The UE 11 may be an Internet of Things UE, such as a sensor device, a mobile phone (or “cellular” phone) and a computer with an Internet of Things UE. For example, it may be a fixed, portable, pocket-sized, handheld, computer-built-in or vehicle-mounted apparatus, such as a station (STA), a subscriber unit, a subscriber station, a mobile station, a mobile, a remote station, an access point, a remote UE (remote terminal), an access UE (access terminal), a user apparatus (user terminal), a user agent, a user device, or a user equipment (UE). Alternatively, the UE 11 may be a device of an unmanned aerial vehicle. Alternatively, the UE 11 may also be a vehicle-mounted device, for example, it may be an on-board computer with a wireless communication function, or a wireless communication device externally connected to an on-board computer. Alternatively, the UE 11 may also be a roadside device, for example, it may be a streetlight, a signal light or other roadside device with wireless communication function.

The access device 12 may be a network-side device in the wireless communication system. The wireless communication system may be the 4th generation mobile communication (4G) system, also known as the Long Term Evolution (LTE) system; or the wireless communication system may also be a 5G system, also called new radio (NR) system or 5G NR system. Alternatively, the wireless communication system may also be a next-generation system of the 5G system. The access network in the 5G system may be called New Generation-Radio Access Network (NG-RAN). Or, it may be a Machine Type Communication (MTC) system. In the communication field, the MTC is mainly used for connecting any type of IoT device.

The access device 12 may be an evolved access device (eNB) used in the 4G system. Alternatively, the access device 12 may also be an access device (gNB) using a centralized and distributed architecture in the 5G system. When the access device 12 adopts the centralized and distributed architecture, it usually includes a central unit (CU) and at least two distributed units (DUs). The central unit is provided with protocol stacks of the Packet Data Convergence Protocol (PDCP) layer, the Radio Link Control protocol (Radio Link Control, RLC) layer, and the Media Access Control (MAC) layer; and the distributed unit is provided with a protocol stack of physical (PHY) layer, and the embodiments of the present disclosure do not limit the specific implementation of the access device 12.

A wireless connection can be established between the access device 12 and the UE 11 through a wireless air interface. In different implementations, the wireless air interface is a wireless air interface based on the fourth generation mobile communication network technology (4G) standard; or the wireless air interface is a wireless air interface based on the fifth generation mobile communication network technology (5G) standard, for example, the wireless air interface is a new air interface; alternatively, the wireless air interface may also be a wireless air interface based on the next generation mobile communication network technology standard of 5G.

As shown in FIG. 2, an embodiment of the present disclosure provides an information processing method, which is executed by a first network device. The method includes at least the following step.

In S1110, first information is sent to a second network device and/or UE, where the first information is used for the second network device or the UE to determine an interruption period and/or a connection period of a feeder link between the first network device and a ground station.

The first network device includes but is not limited to an access device of NTN, for example, a base station of NTN, and the base station includes but is not limited to a gNB. The base station of NTN may be specifically a satellite deployed with gNB function.

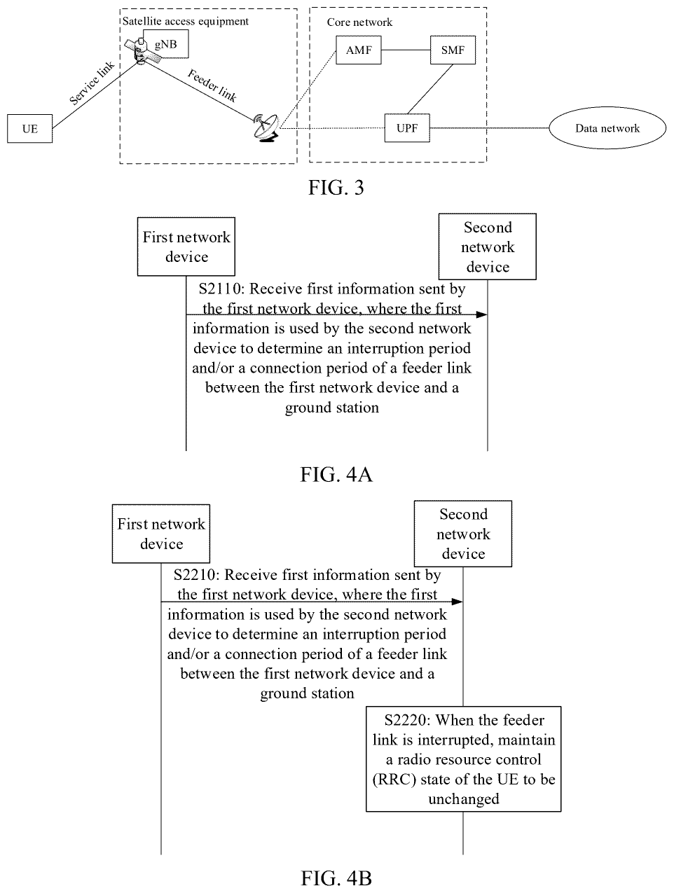

The first network device may be located in the air and may be the satellite access device referenced with respect to FIG. 3.

The ground station connects the satellite deployed with the gNB function and the 5G core network, and is responsible for forwarding signaling and data between the access network and the core network.

As shown in FIG. 3, a service link is established between the UE and the satellite access device; a feeder link is established between the satellite access device and the ground station. The ground station is connected to the core network. The core network includes: an Access Management Function (AMF), a User Plane Function (UPF), and a Session Management Function (SMF). The core network may be connected to the data network.

There is a feeder link between the first network device and the ground station. If the feeder link remains connected, data and/or signaling can be transmitted between the first network device and the ground station; if the feeder link is interrupted, no data and/or signaling can be transmitted between the first network device and the ground station.

In some embodiments, the first network device may determine first information based on its own operating trajectory and the location of the ground station, and send the first information to the second network device and/or the UE.

The first information here may be any information used to determine whether the feeder link between the first network device and the ground station remains connected or interrupted.

The second network device may be a core network device. The UE may be a UE that establishes a connection with the first network device.

Exemplarily, the first network device sends the first information to the second network device and/or the user equipment respectively before the feeder link is interrupted.

As another example, the first network device knows the change of the feeder link within its one operating cycle, and can send the first information to the second network device periodically or based on a trigger event in any condition in which the feeder link is not interrupted.

As another example, the first network device sends the first information to the UE in a case that the service link with the UE is not interrupted.

In short, the first network device may provide the first information to the second network device and/or the UE to facilitate the second network device and/or the UE to perform relevant processes of the service data.

In some embodiments, the first information includes at least one of the following:
ephemeris information of the first network device; or
location information of the ground station.

The ephemeris information of the first network device reflects the operation information of the first network device, and combined with the location information of the ground station, the feeder link connection information can be determined.

In some embodiments, the first information may also be directly calculated by the first network device itself, directly indicating the time information for the feeder link to remain connected and/or interrupted.

In short, there are many specific information forms of the first information, and the specific implementation is not limited to any of the above.

In some embodiments, determining the interruption period and/or connection period of the feeder link includes determining at least one of the following:
connection establishment time information of the feeder link;
connection duration information of the feeder link;
connection interruption time information of the feeder link; or
connection recovery time information of the feeder link.

For example, any one of these are determined according to the first information. Alternatively, any of the information can also be used as a component of the first information. One or more of the connection establishment time information of the feeder link, the connection duration information of the feeder link, the connection interruption time information of the feeder link, and the connection recovery time information of the feeder link can be used by the second network device/or UE to completely determine the connection or interruption of the feeder link between the first network device and the ground station, so that the service data can be buffered during the interruption period of the feeder link, and some high-latency tolerant services are carried out in the case of discontinuous connection of the feeder link.

The establishment time information may include absolute time or an offset relative to the starting time of one operation cycle of the first network device.

The connection duration information may include: duration information and/or a time offset relative to the current connection establishment or recovery moment of the feeder link.

The connection interruption time information may include: interruption starting time information of the feeder link, interruption duration information of the feeder link, interruption ending time information of the feeder link, etc.

The connection recovery time information may include: connection recovery starting time information of the feeder link, duration information of a single recovery the feeder link, recovery ending time information of the feeder link, etc.

In some embodiments, the first information between the first network device information and the ground station is sent to the second network device in at least one of the following processes:
an initial registration process initiated by the UE;
a registration update process initiated by the UE;
a Protocol Data Unit (PDU) session establishment process initiated by the UE;
a PDU session modification process initiated by the UE;
a service request process initiated by the UE; or
an access network (AN) connection release process initiated by a RAN.

For example, after the UE is turned on or exits the flight mode, it initiates an initial registration process to the network. In the initial registration process, the UE may send a registration request message to the network side, the first network device may add the first information in the registration request message sent by the UE, and send the registration request message with the first information added to the second core network device. The first network device receives a registration response message returned by the second network device based on the registration request message. The first network device may add the first information to the registration response message, and then returns the first information to the UE.

In some embodiments, the UE may initiate a registration update triggered by position movement or a periodic registration update process initiated based on a network instruction. During the registration update process, the UE may send a registration update message to the first network device, and after receiving the registration update message, the first network device may send the registration update message together with the first information to the second network device. After receiving the registration update message, the second network device returns a registration update response message. In this way, after receiving the registration update response message, the first network device can provide the registration update response message together with the first information to the UE.

In some embodiments, when the UE wants to establish a PDU session, it may initiate a PDU session establishment process. In the PDU session establishment process, the UE sends a PDU session request message to the first network device. After receiving the PDU session request message, the first network device may send the PDU session request message together with the first information to the second network device. After receiving the PDU session request message, the second network device may return a PDU session response message. In this way, after receiving the PDU session response message, the first network device can provide the PDU session response message together with the first information to the UE.

In some embodiments, when the UE wants to update the PDU session, it may initiate a PDU session modification process. In the PDU session update and modification, the UE sends a PDU session modification message to the first network device. After receiving the PDU session modification message, the first network device may send the PDU session modification message together with the first information to the second network device. After receiving the PDU session modification message, the second network device may return a PDU session response message. In this way, after receiving the PDU session response message, the first network device can provide the PDU session response message together with the first information to the UE.

When the UE needs to request a service, it may initiate a service request process. In the service request process, the UE may send a service request to the first network device. After the service request is forwarded by the first network device to the second network device, the second network device may send a service response. After receiving the service request, the first network device may send the first information together with the service request to the second network device. After receiving the service response and before forwarding the service response to the UE, the first information is added to the service response.

The RAN detects the need to initiate a connection release process, or the access network (AN) connection release process initiated by the RAN. During the AN connection release process, the first network device may carry the feeder link in any message in the connection release process and send it to the UE, and carry the first information in the N2 connection release process, thereby providing the first information to the second network device.

Exemplarily, in the embodiments of the present disclosure, the RAN initiating the AN connection release process refers to the process in which the first network device initiates to the UE to release the connection with the first network device.

The above only provides the feeder link message to transmit the first information in any one or more messages in each process.

In some embodiments, the method further includes:
when it is determined that the feeder link is interrupted according to the first information, buffering uplink data of the user equipment (UE).

If the feeder link is interrupted, but the service link between the UE and the first network device remains connected, the UE and the first network device can communicate with each other at this time, and the first network device buffers the data sent by the UE.

The buffered uplink data may be forwarded to a peer device through the ground station when the feeder link connection is restored. The peer device may include a core network device and/or other terminal device.

As shown in FIG. 4A, an embodiment of the present disclosure provides an information processing method, which is executed by a second network device. The method includes at least the following step.

In S2110, first information sent by a first network device is received, where the first information is used by the second network device to determine an interruption period and/or a connection period of a feeder link between the first network device and a ground station.

The second network device here may be a core network device. The core network device may include but is not limited to an Access Management Function (AMF).

The second network device may receive the first information from the first network device to determine the connection or interruption period of the feeder link between the first network device and the ground station, thereby deciding when to buffer the downlink data.

As shown in FIG. 4B, an embodiment of the present disclosure provides an information processing method, which is executed by a second network device. The method includes at least the following steps.

In S2210, first information sent by a first network device is received, where the first information is used by the second network device to determine an interruption period and/or a connection period of a feeder link between the first network device and a ground station.

In S2220, when the feeder link is interrupted, a radio resource control (RRC) state of the UE is maintained to be unchanged.

The RRC state here may be the connection state between the UE and the first network device and/or the core network. For example, the RRC state may at least include: the RRC connected state and/or the RRC idle state of the UE.

In some cases, the RRC connected state may be referred to as the connected state; the RRC idle state may be referred to as the idle state.

Exemplarily, steps S2120 and/or S2220 may include:
when the UE is in the idle state before the feeder link is interrupted, maintaining the UE in the idle state;
or
when the UE is in the connected state before the feeder link is interrupted, maintaining the UE in the connected state.

In this way, if the state of the UE on the network side is recorded as connected after the feeder link is interrupted, the third network device is instructed to buffer the service data of the UE when receiving the service data of the UE. After the feeder link is restored, the service data is provided to the first network device through the ground station, and is delivered to the UE by the first network device.

In some embodiments, the method further includes:
when the feeder link is interrupted, sending a buffer instruction to a third network device, where the buffer instruction is used by the third network device to buffer the downlink data of the UE.

The third network device buffers the downlink data of the UE according to the buffer instruction.

The third network device may also be a core network device. For example, the third core network device may be different from the second core network device. For example, the third core network device may include but is not limited to: a user plane function (UPF) and/or a session management function (SMF).

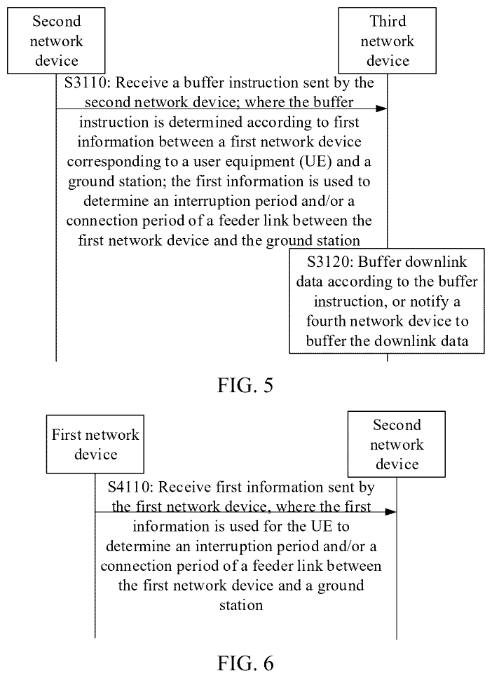

As shown in FIG. 5, an embodiment of the present disclosure provides an information processing method, which is executed by a third network device. The method includes at least the following steps.

In S3110, a buffer instruction sent by a second network device is received; where the buffer instruction is determined according to first information between a first network device corresponding to a user equipment (UE) and a ground station; the first information is used to determine an interruption period and/or a connection period of a feeder link between the first network device and the ground station.

In S3120: downlink data is buffered according to the buffer instruction, or a fourth network device is notified to buffer the downlink data.

The third network device may be UPF or SMF.

In the embodiments of the present disclosure, the third network device may receive the buffer instruction, which is generated due to the connection or interruption of the feeder link between the first network device and the ground station.

Exemplarily, this buffer instruction is usually used to buffer the downlink data of the UE when the feeder link is interrupted.

Exemplarily, the buffer instruction includes at least one of the following: buffer time information; identification information of the UE.

The identification information of the UE may include but is not limited to at least one of the following:
a Subscription Concealed Identifier (SUCI), a Globally Unique Temporary Identifier (GUTI) and a Permanent Equipment Identifier (PEI).

The buffer time information may include: buffer starting time information and buffer ending time information; the buffer starting time information and buffer duration, etc. In short, the buffer time information may be used by the third network device to determine the duration for which downlink data of the UE needs to be buffered.

In one embodiment, after receiving the buffer instruction, the third network device may buffer the downlink data of the UE by itself.

In another embodiment, after receiving the buffer instruction, the third network device notifies the fourth network device to buffer the downlink data of the UE.

Exemplarily, the fourth network device may include but is not limited to UPF.

As shown in FIG. 6, an embodiment of the present disclosure provides an information processing method, which is executed by a user equipment (UE). The method includes at least the following step.

In S4110, first information sent by a first network device is received, where the first information is used for the UE to determine an interruption period and/or a connection period of a feeder link between the first network device and a ground station.

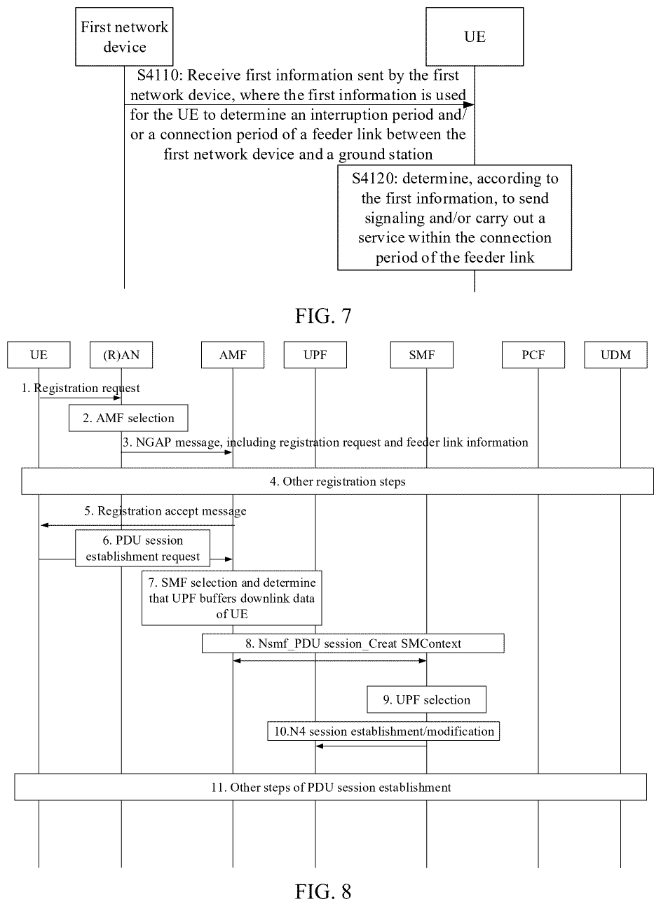

As shown in FIG. 7, an embodiment of the present disclosure provides an information processing method, which is executed by user equipment (UE). The method includes at least the following steps.

In S4110, first information sent by a first network device is received, where the first information is used for the UE to determine an interruption period and/or a connection period of a feeder link between the first network device and a ground station.

In S4120, it is determined, according to the first information, to send signaling and/or carry out a service within the connection period of the feeder link.

In some embodiments, after receiving the first information, the UE may send uplink signaling and start a service during the connection period in which the feeder link remains connected.

For the specific content of the first information, the foregoing embodiments may be referred to, and the details will not be repeated here.

In some embodiments, the S4110 may include: receiving a system information block (SIB) containing the first information.

The first information may be carried in the SIB, and the SIB is broadcast. In this way, the UE can receive the first information even if it does not establish a connection with the first network device. That is, the UE can listen to the SIB when it is in an idle state or at the edge of the cell formed by the first network device before entering the cell formed by the first network device, thereby obtaining the first information.

The embodiment of the present disclosure proposes a connection processing method under satellite access.

Since the orbit and moving speed of the satellite are usually fixed, it can be considered that the feeder link between the satellite and the ground receiving station is predictable. Based on this assumption, the implementation scheme of the embodiment of the present disclosure is as follows.

The first network device (gNB) provides feeder link information to the second network device (core network element, such as AMF, or UE).

The first information may directly describe: connection duration, connection establishment time, connection interruption time, and next connection restoration establishment time of the feeder link.

The first information is: information through which the connection duration, connection establishment time, connection interruption time and next connection restoration establishment time of the feeder link can be determined.

For example, the first information may include, but is not limited to: satellite operating trajectory information (for example, ephemeris information), location information of the ground station, etc.

The first information may be provided by the first network device to the second network device during the initial registration, registration update, and PDU session operation phases of the UE.

If the second network device is the AMF, the AMF determines, according to the first information, that the original state of the UE is still maintained when the feeder link is interrupted. For example, if the UE is in the connected state before the feeder link is interrupted, then after the feeder link is interrupted, the network side still records that the UE is in the connected state.

The AMF may also determine, according to the first information, to start downlink data buffering on the SMF or UPF when the feeder link is interrupted.

The UE determines whether the current network is reachable according to the first information, so that it can decide whether to initiate network registration, or whether to carry out services, etc.

During the initial access of the UE to the network described in this embodiment, the gNB sends the first information to the AMF through an NGAP message, so that the AMF maintains the state of the UE and determines downlink data buffering according to the first information.

As shown in FIG. 8, an embodiment of the present disclosure provides an information processing method, which may include at least the following steps.

1. The UE accesses the network and initiates initial registration.

2. The gNB receives a registration message and selects an AMF for providing access service to the UE according to the UE information carried in the request message.

3. The gNB sends an NGAP message to the AMF, carrying the registration request and the first information. The first information is the connection duration, the connection establishment time, the connection interruption time, and the next connection restoration establishment time of the feeder link. Alternatively, the link information of the feeder link may be: information through which the connection duration, connection establishment time, connection interruption time and next connection restoration establishment time of the feeder link can be determined, for example, satellite operating trajectory (ephemeris information) information and location information of the ground station, etc.

4. Other procedures for completing registration between the UE and the network.

5. The AMF returns a successful registration response to the UE. Thereafter, the AMF needs to combine the first information when maintaining the state of the UE. For example, the UE is in the connected state. At this time, if the AMF determines that the feeder link is interrupted, the AMF should not change the state of the UE recorded on the network side to the idle state, or de-register the UE.

6. The UE initiates a PDU session establishment request.

7. After receiving the PDU session establishment request, the AMF selects an SMF for establishing the PDU session for the UE, and determines the time and/or duration for the UPF to buffer downlink data according to the first information.

8. A session is established between the AMF and the SMF, and the buffering time and/or duration of the downlink data is sent to the SMF.

9. The SMF selects a UPF for the PDU session of the UE.

10. An N4 session is established between the SMF and the UPF, and the SMF sends the buffering time and/or duration of the downlink data to the SMF.

11. The rest procedure for completing the PDU session establishment between the UE and the network.

After the PDU session is established between the UE and the network, the UE can exchange service data with the DN network through the PDU session. The UPF determines when to start buffering the downlink data according to the buffering time and/or duration of the downlink data issued by the SMF, that is, it ensures that when the satellite used by the UE for access is interrupted in the feeder link, the downlink data is buffered in the UPF, and when the feeder link connection is restored, the UPF continues to send the downlink buffered data to the UE.

The UE described in this embodiment receives the first information of the current satellite through the broadcast message, and determines whether to currently access the network or whether to carry out the services according to the information, etc.

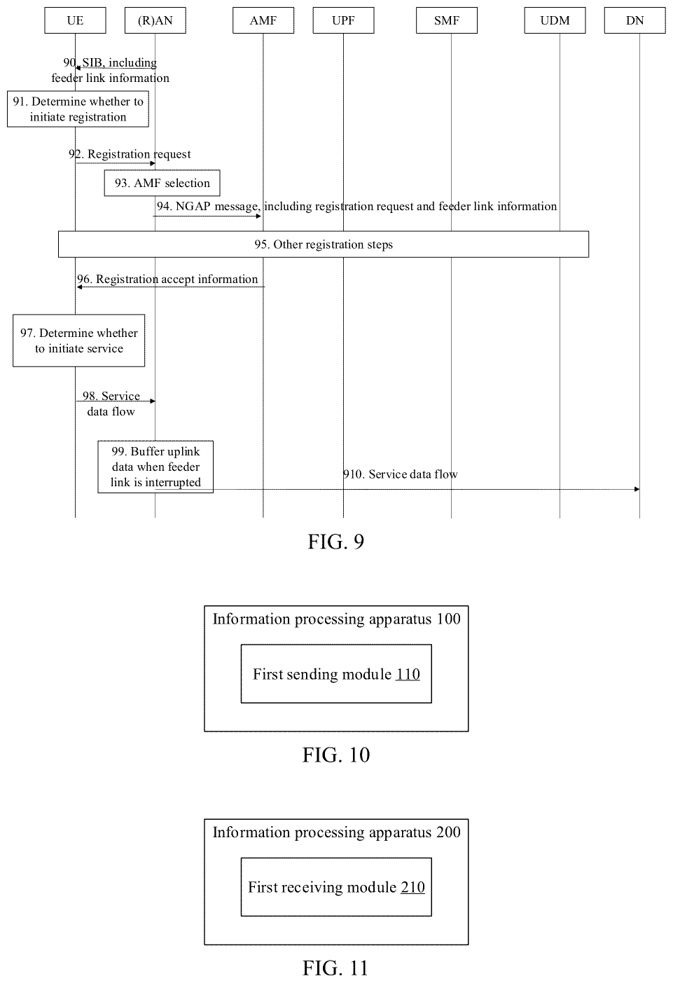

As shown in FIG. 9, the embodiment of the present disclosure provides an information processing method, which may include at least the following steps.

90. The gNB broadcasts a message to the UE, and the broadcast message includes the first information.

91. The UE can determine the existence time and/or duration of the feeder link according to the first information, and determine when access registration can be initiated according to the information. If the feeder link is in the interrupted state at this time, the UE decides not to initiate the registration procedure and the following steps are ignored. Otherwise,

92. The UE accesses the network and initiates initial registration.

93. The gNB receives the registration message and selects the AMF that serves for access of the UE according to the UE information carried in the request message.

94. The gNB sends an NGAP message to the AMF, carrying the registration request and the first information. The first information is: the connection duration, the connection establishment time, the connection interruption time, the next connection restoration establishment time of the feeder link, etc. Alternatively, the first information is information through which the connection duration, connection establishment time, connection interruption time and/or the next connection restoration establishment time of the feeder link can be determined, such as satellite operating trajectory (ephemeris information), location of the ground station, etc.

95. Other procedures for completing registration between the UE and the network.

96. The AMF returns a successful registration response to the UE. Thereafter, the AMF needs to combine the feeder link information when maintaining the state of the UE. For example, if the UE is in the active state and the AMF determines that the feeder link is interrupted, the AMF should not change the UE to idle state or de-register the UE, so that the UE can still carry out a service normally and the application server can still send downlink service data to the UE.

97. The UE can carry out the service after completing the PDU session establishment. The UE determines whether the delay of the service to be carried out can tolerate the interruption duration of the feeder link according to the interruption duration of the feeder link. If it can, the service can be carried out, otherwise the service will not be carried out.

98. The UE carries out the service and sends uplink service data.

99. If the gNB determines that the feeder link is interrupted at this time, the gNB buffers the uplink service data.

910. When the gNB determines that the feeder link is restored, the gNB sends the buffered uplink service data to the UPF.

As shown in FIG. 10, an embodiment of the present disclosure provides an information processing apparatus 100. The apparatus 100 includes a first sending module 110.

The first sending module 110 is configured to send first information to a second network device and/or a user equipment (UE), where the first information is used for the second network device or the UE to determine an interruption period and/or a connection period of a feeder link between the first network device and a ground station.

The information processing apparatus 100 may be included in the first network device.

In some embodiments, the first sending module 110 may be a program module; and after the program module is executed by a processor, the foregoing operations can be implemented.

In other embodiments, the first sending module 110 may be a software and hardware combination module. The software and hardware combination module includes, but is not limited to, a programmable array. The programmable array includes, but is not limited to, a field programmable array and/or a complex programmable array.

In some embodiments, the first sending module 110 may also include a pure hardware module; and the pure hardware module includes, but is not limited to: an application specific integrated circuit.

In some embodiments, the first information includes at least one of the following:
ephemeris information of the first network device; or
location information of the ground station.

In some embodiments, determining the interruption period and/or the connection period of the feeder link includes determining at least one of the following:
connection establishment time information of the feeder link;
connection duration information of the feeder link;
connection interruption time information of the feeder link; or
connection recovery time information of the feeder link.

In some embodiments, the first sending module 110 is configured to send the first information between the first network device information and the ground station to the second network device in at least one of the following processes:
an initial registration process initiated by the UE;
a registration update process initiated by the UE;
a PDU session establishment process initiated by the UE;
a PDU session modification process initiated by the UE;
a service request process initiated by the UE; or
an access network (AN) connection release process initiated by RAN.

In some embodiments, the apparatus 100 further includes:
a first buffer module, configured to buffer uplink data of the user equipment (UE) when it is determined that the feeder link is interrupted according to the first information.

As shown in FIG. 11, an embodiment of the present disclosure provides an information processing apparatus 200. The apparatus 200 includes a first receiving module 210.

The first receiving module 210 is configured to receive first information sent by a first network device, where the first information is used for a second network device to determine an interruption period and/or a connection period of a feeder link between the first network device and a ground station.

The information processing apparatus 200 may be included in the second network device.

In some embodiments, the first receiving module 210 may be a program module; and after the program module is executed by a processor, the foregoing operations can be implemented.

In other embodiments, the first receiving module 210 may be a software and hardware combination module. The software and hardware combination module includes, but is not limited to, a programmable array. The programmable array includes, but is not limited to, a field programmable array and/or a complex programmable array.

In some embodiments, the first receiving module 210 may also include a pure hardware module; and the pure hardware module includes but is not limited to: an application specific integrated circuit.

In some embodiments, the apparatus 200 further includes:
a maintenance module, configured to maintain a radio resource control (RRC) state of the UE to be unchanged when the feeder link is interrupted.

In some embodiments, the apparatus further includes:
a second sending module (not shown), configured to send a buffer instruction to a third network device for the third network device to buffer downlink data of the UE when the feeder link is interrupted.

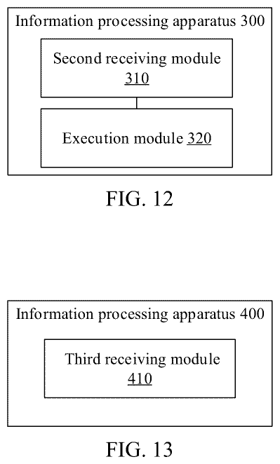

As shown in FIG. 12, an embodiment of the present disclosure provides an information processing apparatus 300, which includes a second receiving module 310 and an execution module 320.

The second receiving module 310 is configured to receive a buffer instruction sent by a second network device; where the buffer instruction is determined according to first information between a first network device corresponding to a user equipment (UE) and a ground station; the first information is used to determine an interruption period and/or a connection period of a feeder link between the first network device and the ground station.

The execution module 320 is configured to buffer downlink data according to the buffer instruction, or to notify a fourth network device to buffer the downlink data.

The information processing apparatus 300 may be included in the second network device.

In some embodiments, the second receiving module 310 may be a program module; and after the program module is executed by the processor, the foregoing operations can be implemented.

In other embodiments, the second receiving module 310 may be a software and hardware combination module. The software and hardware combination module includes, but is not limited to, a programmable array. The programmable array includes, but is not limited to, a field programmable array and/or a complex programmable array.

In some embodiments, the second receiving module 310 may also include a pure hardware module; and the pure hardware module includes, but is not limited to: an application specific integrated circuit.

As shown in FIG. 13, an embodiment of the present disclosure provides an information processing apparatus 400. The apparatus 400 includes a third receiving module 410.

The third receiving module 410 is configured to receive first information sent by a first network device, where the first information is used for a UE to determine an interruption period and/or a connection period of a feeder link between the first network device and a ground station.

The information processing apparatus 400 may be included in the UE.

In some embodiments, the third receiving module 410 may be a program module; and after the program module is executed by a processor, the above operations can be implemented.

In other embodiments, the third receiving module 410 may be a software and hardware combination module. The software and hardware combination module includes, but is not limited to, a programmable array. The programmable array includes, but is not limited to, a field programmable array and/or a complex programmable array.

In some embodiments, the third receiving module 410 may also include a pure hardware module; and the pure hardware module includes, but is not limited to: an application specific integrated circuit.

In some embodiments, the apparatus 400 further includes:
a third sending module (not shown), configured to determine, according to the first information, to send signaling and/or carry out a service within the connection period of the feeder link.

In some embodiments, the third receiving module 410 is configured to receive a system information (SIB) containing the first information.

An embodiment of the present disclosure provides a communication device, including:
a memory used to store instructions executable by a processor(s); and
the processor(s) connected to the memory respectively;
where the processor(s) is configured to execute the information processing method provided by any of the foregoing technical solutions.

The processor may include various types of storage media, which are non-transitory computer-readable storage media that can continue to store information stored thereon after the communication device is powered off.

Here, the communication device includes: a UE or the aforementioned network devices, and the network device may be any one of the aforementioned first to fourth network devices.

The processor can be connected to the memory through a bus, etc., and is used to read the executable program stored in the memory, for example, at least one of the methods shown in FIG. 2, FIG. 4A, FIG. 4B, FIG. 5 to FIG. 9.

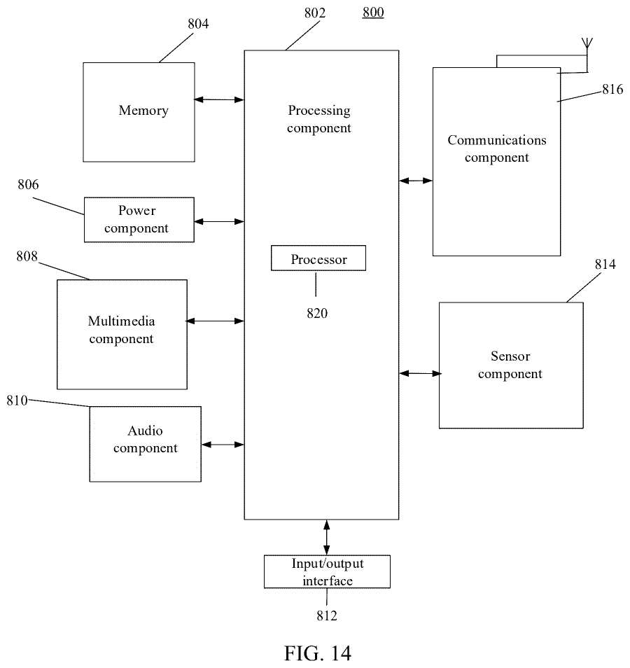

FIG. 14 is a block diagram of a UE 800 according to an exemplary embodiment. For example, the UE 800 may be a mobile phone, a computer, a digital broadcast user equipment, a messaging device, a game console, a tablet, a medical device, exercise equipment, a personal digital assistant, and the like.

Referring to FIG. 14, the UE 800 may include one or more of the following components: a processing component 802, a memory 804, a power component 806, a multimedia component 808, an audio component 810, an input/output (I/O) interface 812, a sensor component 814, and communications component 816.

The processing component 802 typically controls overall operations of the UE 800, such as the operations associated with display, telephone calls, data communications, camera operations, and recording operations. The processing component 802 may include one or more processors 820 to execute instructions to generate all or part of the steps of the methods described above. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operations of the UE 800. Examples of such data include instructions for any applications or methods operated on the UE 800, contact data, phonebook data, messages, pictures, videos, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EEPROM), a programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or slide action, but also sense a period of time and a pressure associated with the touch or slide action. In some embodiments, the multimedia component 808 includes a front camera and/or a rear camera. The front camera and/or the rear camera may receive an external multimedia data while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the UE 800. For example, the sensor component 814 may detect an open/closed status of the device 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor assembly 814 may include a proximity sensor configured to detect the presence of nearby objects without any physical contact. The sensor assembly 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate communication, wired or wirelessly, between the UE 800 and other devices. The UE 800 can access a wireless network based on a communication standard, such as WiFi, 2G or 3G, or a combination thereof. In one exemplary embodiment, the communication component 816 receives a broadcast signal or broadcast related information from an external broadcast management system via a broadcast channel. In one exemplary embodiment, the communications component 816 further includes a near field communications (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the UE 800 may be implemented with one or more application specific integrated circuits (ASICs), digital signal processors (DSPs), digital signal processing devices (DSPDs), programmable logic devices (PLDs), field programmable Gate arrays (FPGAs), controllers, micro-controllers, microprocessors, or other electronic components, for performing the above-described methods.

In exemplary embodiments, there is also provided a non-transitory computer-readable storage medium including instructions, such as included in the memory 804, executable by the processor 820 in the UE 800, for generating the above-described methods. For example, the non-transitory computer-readable storage medium may be a ROM, a random access memory (RAM), a CD-ROM, a magnetic tape, a floppy disc, an optical data storage device, and the like.

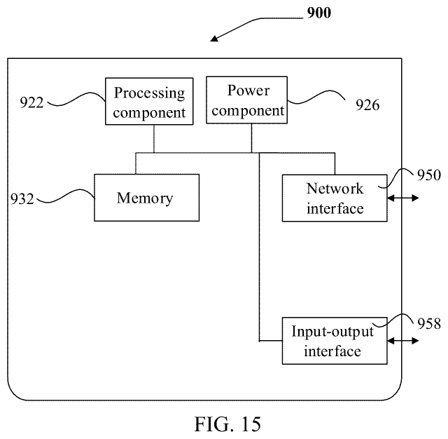

As shown in FIG. 15, an embodiment of the present disclosure illustrates a structure of a network device. For example, the network device 900 may be provided as a network side device. The communication device may be various network elements, such as the above-mentioned access network elements and/or network functions.

Referring to FIG. 15, the network device 900 includes a processing component 922, which further includes one or more processors (not shown), and a memory resource represented by a memory 932 for storing instructions executable by the processing component 922, such as an application program. The application program stored in the memory 932 may include one or more modules, each corresponding to a set of instructions. In addition, the processing component 922 is configured to execute instructions to perform any of the above-mentioned methods applied to the access device, for example, at least one of the methods shown in FIG. 2, FIG. 4A, FIG. 4B, and FIG. 5 to FIG. 9.

The network device 900 may further include a power component 926 configured to perform power management of the network device 900, a wired or wireless network interface 950 configured to connect the network device 900 to a network, and an input-output (I/O) interface 958. The network device 900 may operate based on an operating system stored in the memory 932, such as Windows Server™, Mac OS X™, Unix™, Linux™, FreeBSD™ or the like.

Other embodiments of the present disclosure will be apparent to those skilled in the art from consideration of the specification and practice of the contents disclosed here. The present disclosure is intended to cover any variations, uses, or adaptations of the present disclosure, which follows the general principles thereof and includes the common knowledge or habitual technical means in this technical field that is not disclosed in the present disclosure. The specification and the embodiments are considered as exemplary only, with a true scope and spirit of the present disclosure being indicated by the appending claims.

It will be appreciated that the present disclosure is not limited to the exact construction that has been described above and illustrated in the accompanying drawings, and various modifications and changes can be made without departing from the scope thereof. The scope of the present disclosure is only limited by the appended claims.

1. An information processing method, executed by a first network device, wherein the method comprises:
sending first information to at least one of a second network device or a user equipment (UE), wherein the first information is used for the second network device or the UE to determine at least one of an interruption period or a connection period of a feeder link between the first network device and a ground station.

2. The method according to claim 1, wherein the first information comprises at least one of:
ephemeris information of the first network device;, or
location information of the ground station.

3. The method according to claim 2, wherein determining at least one of the interruption period or the connection period of the feeder link comprises determining at least one of:
connection establishment time information of the feeder link,
connection duration information of the feeder link,
connection interruption time information of the feeder link, or
connection recovery time information of the feeder link.

4. The method according to claim 1, wherein in at least one of following processes, the first information between the first network device and the ground station is sent to the second network device:
an initial registration process initiated by the UE,
a registration update process initiated by the UE,
a protocol data unit (PDU) session establishment process initiated by the UE,
a PDU session modification process initiated by the UE,
a service request process initiated by the UE, or
an access network (AN) connection release process initiated by a Radio Access Network (RAN).

5. The method according to claim 1, further comprising:
in response to a determination that the feeder link is interrupted according to the first information, buffering uplink data of the UE.

6. An information processing method, executed by a second network device, wherein the method comprises:
receiving first information sent by a first network device, wherein the first information is used by the second network device to determine at least one of an interruption period or a connection period of a feeder link between the first network device and a ground station.

7. The method according to claim 6, further comprising:
in response to that the feeder link is interrupted, maintaining a radio resource control (RRC) state of a UE to be unchanged.

8. The method according to claim 7, further comprising:
in response to that the feeder link is interrupted, sending a buffer instruction to a third network device; wherein the buffer instruction is used for the third network device to buffer downlink data of the UE.

9. (canceled)

10. An information processing method, executed by a user equipment (UE), wherein the method comprises:
receiving first information sent by a first network device, wherein the first information is used for the UE to determine at least one of an interruption period or a connection period of a feeder link between the first network device and a ground station.

11. The method according to claim 10, further comprising:
determining according to the first information, to perform at least one of sending signaling or carrying out a service within the connection period of the feeder link.

12. The method according to claim 10, wherein receiving the first information sent by the first network device comprises:
receiving a system information block (SIB) containing the first information.

13-24. (canceled)

25. A communication device, comprising:
a processor;
a transceiver; and
a memory storing an executable program capable of being run by the processor, and wherein when the processor runs the executable program, the method according to claim 1 is executed.

26. (canceled)

27. The method according to claim 2, wherein in at least one of following processes, the first information between the first network device and the ground station is sent to the second network device:
an initial registration process initiated by the UE,
a registration update process initiated by the UE,
a protocol data unit (PDU) session establishment process initiated by the UE,
a PDU session modification process initiated by the UE,
a service request process initiated by the UE, or
an access network (AN) connection release process initiated by a Radio Access Network (RAN).

28. The method according to claim 3, wherein in at least one of following processes, the first information between the first network device and the ground station is sent to the second network device:
an initial registration process initiated by the UE,
a registration update process initiated by the UE,
a protocol data unit (PDU) session establishment process initiated by the UE,
a PDU session modification process initiated by the UE,
a service request process initiated by the UE, or
an access network (AN) connection release process initiated by a Radio Access Network (RAN).

29. The method according to claim 2, further comprising:
in response to determination that the feeder link is interrupted according to the first information, buffering uplink data of the UE.

30. The method according to claim 3, further comprising:
in response to determination that the feeder link is interrupted according to the first information, buffering uplink data of the UE.

31. The method according to claim 4, further comprising:
in response to determination that the feeder link is interrupted according to the first information, buffering uplink data of the UE.

32. The method according to claim 11, wherein receiving the first information sent by the first network device comprises:
receiving a system information block (SIB) containing the first information.

33. A communication device, comprising:
a processor;
a transceiver; and
a memory storing an executable program capable of being run by the processor, and wherein when the processor runs the executable program, the method according to claim 6 is executed.

34. A communication device, comprising:
a processor;
a transceiver; and
a memory storing an executable program capable of being run by the processor, and wherein when the processor runs the executable program, the method according to claim 10 is executed.
